(19) United States
(12) Patent Application Publication
(10) Pub. No.: US 2012/0003432 A1
(43) Pub. Date: Jan. 5, 2012

(54) WIPES HAVING A NON-HOMOGENEOUS STRUCTURE

(75) Inventors: Hugh Joseph O'Donnell, Cincinnati, OH (US); Karen Denise McAffry, Cincinnati, OH (US); Joerg Mueller, Karben (DE); Luis Omar Gonzalez-Mendez, Cincinnati, OH (US)

(73) Assignee: The Procter & Gamble Company, Cincinnati, OH (US)

(21) Appl. No.: 13/173,463

(22) Filed: Jun. 30, 2011

Related U.S. Application Data
(60) Provisional application No. 61/360,947, filed on Jul. 2, 2010.

(51) Int. Cl. B32B 7/02; B29C 55/02; B32B 3/02

(52) U.S. Cl. 428/193; 428/212; 264/288.4; 264/145

(57) ABSTRACT

A wipe exhibiting many of the properties that consumers desire for a wipe, i.e. softness, strength, coverage, flexibility and a process of making a wipe at competitive costs are disclosed. The wipe comprises a sheet of fibrous material having regions of a first basis weight and regions of a second basis weight.

### CROSS-REFERENCE TO RELATED APPLICATIONS

This application claims the benefit of U.S. Provisional Application No. 61/360,947, filed Jul. 2, 2010, the substance of which is incorporated herein by reference.

### TECHNICAL FIELD

Wipes, either dry or wet, exhibiting softness, strength, flexibility, coverage and that can be manufactured at lower costs are provided.

### BACKGROUND

Disposable wipes, either wet or dry, are well-known and successfully commercialized for a large variety of uses. For instance, wipes may be used for cleaning hard surfaces such as floors or kitchen surfaces. Wipes may also be used for personal cleaning, for example to remove facial make-up or to clean or refresh the skin whilst traveling. Wipes are also particularly appreciated for cleaning baby's skin in the perianal area during a diaper change.

Typically, wipes comprise a substrate, in the form of a woven or nonwoven sheet. The sheet may be impregnated with a lotion composition wetting the substrate to facilitate cleaning and providing a so-called wet wipe. The lotion composition may deliver additional benefits, e.g. soothing, treating.

Various types of substrates, differing in their visual and tactile properties, may be utilized for manufacturing disposable wipes. When wipes are intended to be used as personal care wipes, such as baby wipes, facial cleansing wipes, intimate cleansing wipes, and the like, softness, flexibility, coverage, effective cleaning ability, strength are properties that matter for the consumers. Thus, over the past decades, research and development efforts were aimed at developing new substrates suitable for manufacturing wipes meeting these expectations.

In the course of these research and developments, it was found that maintaining a right balance of properties is challenging. Typically, when one property is improved, other properties of the substrate may be adversely affected. In addition to this challenge, manufacturers have to control the manufacturing/producing costs in order to deliver wipes at competitive prices, which can find wide acceptance among consumers. This is to the more challenging than in recent years, commodities prices, e.g. raw materials costs, have considerably increased.

To reduce cost, wipes manufacturers have attempted to reduce the overall amount of fibers in these materials to provide substrates of lower basis weights. However, this solution is not completely satisfactory. Basis weight reduction may be noticeable to consumers, either visually or to the touch. This mere sensorial analysis of the wipes may reduce the confidence consumers have in the ability of the wipes to perform the cleaning task efficiently, the wipes appearing more flimsy. They may also feel concern by the fact that the wipe may not protect efficiently their hands from soiling during the cleaning task. Furthermore, basis weight reduction may not only affect the perception the consumers may have of the products. In some instances, basis weight reduction may also affect the physical properties of the wipes. For instance, the strength or coverage of the wipes may be reduced to levels more or less acceptable by the consumers.

Thus, it remains a need for wipes, either dry or wet, that would exhibit a right balance of properties, e.g. softness, strength, flexibility, thickness, coverage and that could be produced at lower costs. The reduction in the manufacturing costs should not affect the perception the consumers have of the wipes, nor their cleaning efficiency. The wipes should remain thick enough to make the consumer confident in the cleaning performance of the wipes and provide good hand coverage during the cleaning tasks. The wipes should also be soft to be gentle to the skin, flexible, strong and visually attractive, this at low costs.

### SUMMARY

A wipe comprising a sheet of fibrous material includes at least one region of a first basis weight and at least one region of a second basis weight, where the fibrous material in said region(s) of a first basis weight of said sheet is elongated relative to the fibrous material in said region(s) of a second basis weight of said sheet is provided.

### BRIEF DESCRIPTION OF THE DRAWINGS

FIG. 1 is a schematic top view of a wipe in accordance with one or more embodiments of the invention.

FIG. 2 is a schematic top view of a wipe in accordance with one or more embodiments of the invention.

FIG. 3 is a schematic top view of a wipe in accordance with one or more embodiments of the invention.

FIG. 4 is a schematic top view of a wipe in accordance with one or more embodiments of the invention.

FIG. 5 is a schematic top view of a wipe in accordance with one or more embodiments of the invention.

FIG. 6 is a schematic top view of a wipe in accordance with one or more embodiments of the invention.

FIG. 7 is a schematic representation of a device for mechanically activating a fibrous material.

FIG. 8 is a schematic cross-sectional view of a device for mechanically activating a fibrous material.

### DETAILED DESCRIPTION

The present disclosure is directed to a distinctive wipe comprising a sheet of fibrous material having a non-homogeneous structure, i.e. regions of different basis weight. The sheet comprises at least one region of a first basis weight and at least one region of a second basis weight. The fibrous material in the region(s) of a first basis weight is elongated relative to the fibrous material in the region(s) of a second basis weight. As a consequence of the elongation of the fibrous material, the basis weight of the sheet in the region(s) comprising the elongated fibrous material is reduced. The sheet of fibrous material may be impregnated with a lotion composition to provide a so-called wet wipe. Typical lotion compositions are predominantly water based compositions and can contain a variety of other ingredients. These are usually, surfactants, humectants, emollients, rheology modifiers, soothing agents, cleansers, anti-microbials, preservatives, perfumes and softeners.

It has been found that wipes having regions comprising a fibrous material which is elongated, including where the regions are located in target areas, meet the above needs. Indeed, such wipes provide optimized cleaning performances and exhibit an appropriate balance of properties in terms of visual appearance, softness, drapability, flexibility, strength as well as can be produced with substantial cost savings.

The term “wipe” as used herein, also known as “cleaning sheet”, refers to an article comprising a sheet of fibrous material. Wipes, either dry or wet, are intended to be used for removal of a substance from a surface or object which is animate or inanimate, or alternatively, application of a material to a surface or object which is animate or inanimate. For instance, wipes may be used for cleaning hard surfaces, such as floors. Wipes may also be used for human or animal cleansing or wiping such as anal cleansing, perineal cleansing, genital cleansing, and face and hand cleansing. Wipes may also be used for application of substances to the body, including but not limited to application of make-up, skin conditioners, ointments, and medications. They may also be used for cleaning or grooming of pets. Additionally, they may be used for general cleansing of surfaces and objects, such as household kitchen and bathroom surfaces, eyeglasses, exercise and athletic equipment, automotive surfaces, and the like.

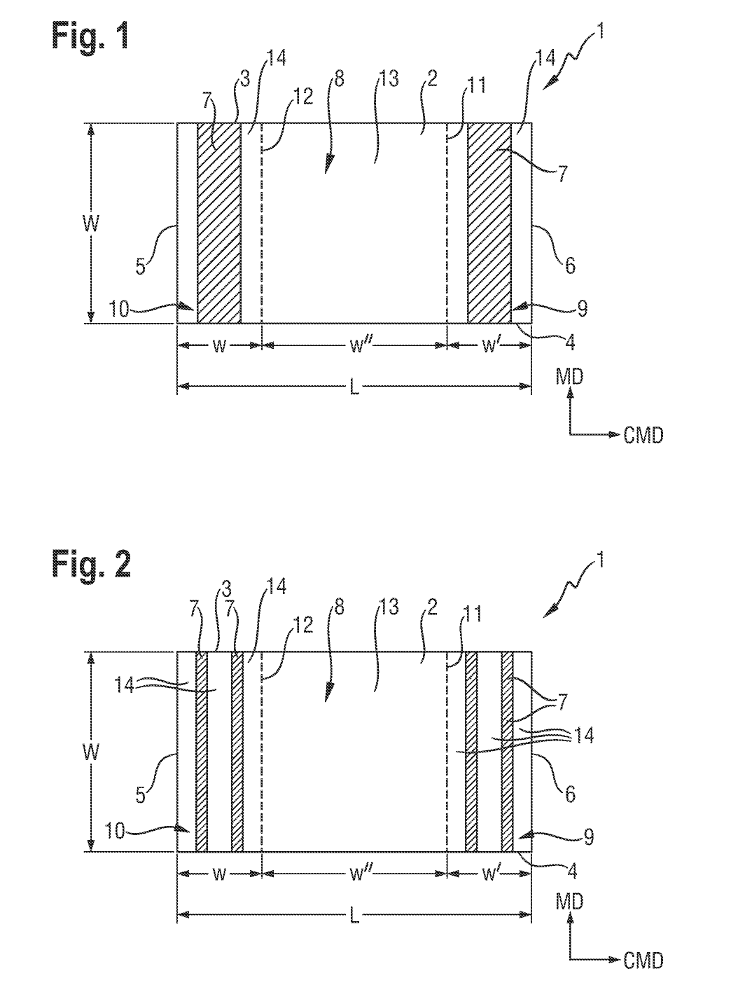

Generally, a wipe is rectangular or square in shape and is defined by two pairs of opposite sides or edges. Each wipe has a width and a length. For example, the wipe may have a length of from about 6 to about 40 cm, or from about 10 to about 25 cm, or from about 15 to about 23 cm, or from about 17 to about 21 cm and may have a width of from about 10 to 25 cm, or from about 15 to about 23 cm, or from about 17 to about 21 cm. Each of FIGS. 1 to 6 illustrates a wipe 1 comprising a sheet of fibrous material 2 having a width W and a length L and which is defined by two pairs of opposite sides or edges 3; 4, 5; 6.

The wipes disclosed herein, either dry or wet, comprise a sheet of fibrous material.

By “sheet of fibrous material” as used herein, it is meant a piece of fibrous material suitable for use as, or in a wipe. Suitable fibrous materials include woven and nonwoven materials, comprising natural fibers or synthetic fibers or combinations thereof. Examples of natural fibers may include cellulosic natural fibers, such as fibers from hardwood sources, softwood sources, or other non-wood plants. The natural fibers may comprise cellulose, starch and combinations thereof. The synthetic fibers can be any material, such as, but not limited to, those selected from the group consisting of polyesters (e.g., polyethylene terephthalate), polyolefins, polypropylenes, polyethylenes, polyethers, polyamides, polyesteramides, polyvinylalcohols, polyhydroxyalkanoates, polysaccharides and combinations thereof. Further, the synthetic fibers can be a single component (i.e., single synthetic material or mixture makes up entire fiber), bi-component (i.e., the fiber is divided into regions, the regions including two or more different synthetic materials or mixtures thereof and may include co-extruded fibers and core and sheath fibers) and combinations thereof. Bi-component fibers can be used as a component fiber of the fibrous material, and/or they may be present to act as a binder for the other fibers present in the material. Any or all of the synthetic fibers may be treated before, during, or after manufacture to change any desired properties of the fibers.

“Nonwoven material” as used herein refers to a manufactured web of directionally or randomly orientated fibers, bonded by friction, and/or cohesion and/or adhesion, excluding paper and products which are woven, knitted, tufted, stitch-bonded incorporating binding yarns or filaments, or felted by wet-milling, whether or not additionally needled. Nonwoven materials may be manufactured by a wide number of known processes. Non-limiting examples of processes include spunbonding, meltblowing, air laying, wet laying, coform, carding, needle-punching, mechanical entangling, thermo-mechanical entangling, hydroentangling, calender bonding and combination thereof.

Suitable sheet of fibrous material include, but are not limited to, carded nonwovens comprising a blend of cellulosic and synthetic fibers. The cellulosic fibers may be present in an amount ranging from about 5% to about 70%, or from about 10% to about 60% or from about 20% to about 50% by weight of the fibrous material. Examples of suitable blends include blends of viscose fibers and polypropylene fibers, wherein the viscose fibers may be present in an amount ranging from about 5% to about 70%, or from about 10% to about 60% or from about 20% to about 50% by weight of the fibrous material. Polyethylene terephthalate fibers may also be added to the blend of viscose fibers and polypropylene fibers.

The sheet of fibrous material may be made of one single layer or may be made of several layers forming a composite sheet of fibrous material. For example, the composite sheet may include a laminate web of two or more nonwoven webs. The laminate web may include spunbond layer(s) (S), and/or meltblown layer(s) (M), and/or carded layer(s) (C), and/or pulp layer(s) (P). Suitable laminate webs include, but are not limited to, SS, SP, SPC, SMS or SMMS.

The sheet of fibrous material may also be combined with one or more other layers, such as layers of extensible material or inextensible material.

The sheet of fibrous material may comprise on at least one of its surface a macroscopic three dimensional pattern which may be defined by peaks and valleys. Said three dimensional patterns may be produced by hydromolding. However, any texturing processes may be suitable to provide macroscopic three dimensional patterns. Three dimensional patterns may enhance the cleaning performance of the wipe made of said sheet.

The sheet of fibrous material comprises at least one region of a first basis weight and at least one region of a second basis weight, wherein the fibrous material in the region(s) of a first basis weight is elongated relative to the fibrous material in the region(s) of a second basis weight.

Thus, it is to be understood that the sheet of fibrous material according to the present disclosure are made of elongatable fibrous material, i.e. fibrous material which, upon application of a biasing force is extensible or elongatable in at least one direction, i.e. in the machine direction and/or cross-machine direction. The term “elongatable” may refer to a fibrous material that, upon application of a biasing force, can stretch to an elongated length of at least 130% of its relaxed, original length (i.e. can stretch to 30% more than its original length), without complete rupture or breakage as measured according to the EDANA method 20.2-89. For example, if a fibrous material having a relaxed length of 1 cm is elongated to a length of 1.5 cm, the fibrous material would be elongated by 50% and would have an elongated length which is 150% of its relaxed length. Upon stretching, the fibrous material undergoes a plastic deformation, i.e. the fibrous material will be to a degree permanently elongated so that upon release of the applied tensile forces, it will not fully return to its original undistorted configuration.

It will be readily apparent to those skilled in the art that the elongation of the fibrous material may be limited intrinsically by the type of fibers and/or the manufacturing process. For instance, it is known that carded fibrous materials offer relatively little resistance to elongation whereas spunbond fibrous materials may be more difficult to elongate without causing the fibrous material to tear. The elongation of the fibrous material may also be limited by the sought desired end properties of the sheet. Thus, the elongation of the fibrous material should be chosen such that it does not impact negatively the visual appearance of the wipes, i.e. the elongation should not tear the fibrous material nor create a wavy pattern at the surface of the wipes where the fibrous material relaxes after elongation.

Table 1 shows examples of fibrous structures associated with percentage of elongation that may be performed to obtain fibrous materials suitable for use according to the present disclosure. The listed fibrous materials are for illustrative purpose only and not intended to be limitative.

For instance, a 50 gsm Carded-Spunlace fibrous structure comprising a mixture of 80% Polypropylene/20% Viscose may be elongated by up to about 85% in the cross-machine direction. It is to be understood that the fibrous structure may still be further elongated in the cross-machine direction, actually up to the elongation at break (about 170%). Nevertheless, above an elongation of 85%, referred herein as the maximal elongation, the elongation of the fibrous structure may become highly noticeable to the consumers and thus less desirable. Typical performed elongations are referred in the table below as “common” elongation.

TABLE 1
Examples of fibrous structure and associated properties

| | Fibrous | | | |
|---|---|---|---|---|
| | Materials⁵ | CD Elongation¹ | | CD Elongation |
| Web making | (%) | % | | at break² |
| process | 50 gsm | Common | Maximal | % |
| Carded- | PP³/Viscose⁴ | 10-45 | 85 | 170 |
| Spunlace | (80/20) | | | |
| Carded- | PP³/Viscose⁴ | 10-40 | 75 | 150 |
| Spunlace | (60/40) | | | |
| Carded | PP³ | 10-80 | 160 | 320 |
| | (100) | | | |

¹CD Elongation refers to the percentage of elongation applied to the fibrous material upon stretching. Subsequent to stretching, the elongated fibrous structure may further slightly relax.
²measured according to EDANA method 20.2-89
³polypropylene fibers (38 mm, 1.9 dtex)
⁴viscose fibers (38 mm, 1.7 dtex)
⁵supplied by Sandier, Germany

As mentioned above, the fibrous material is elongated in some region(s) of the sheet, thus providing a fibrous structure with region(s) of a first basis weight and region(s) of a second basis weight. The fibrous material in the region of a second basis weight may be non-elongated. The elongated fibrous material is elongated throughout the thickness of the fibrous material, i.e. throughout the thickness of the sheet. FIGS. 1 to 6 are illustrative of wipes 1 comprising a sheet of fibrous material 2, wherein said sheet comprises at least one region 7 of a first basis weight and at least one region 8 of a second basis weight.

A “region” as used herein is defined by a portion of the sheet that is homogeneous in a selected defining criterion, herein the basis weight, and is distinguished from neighboring portions by this criterion. For instance, a region as used herein corresponds to a portion of the wipe wherein the basis weight is homogeneous. It will be apparent to one skilled in the art that there may be small transition regions having a basis weight intermediate the first basis weight and the second basis weight or third basis weight. These transition regions by themselves may be not significant enough in area to be considered as comprising a basis weight distinct from the basis weight of the regions of first basis weight and second basis weight. Such transitional regions are within the normal manufacturing variations known and inherent in producing the fibrous structure. When the sheet is a composite sheet, it is to be understood that a “region” of the sheet does not refer to a portion of one layer making the composite sheet taken in isolation from the other layer(s).

The term “basis weight” as used herein refers to the mass of the dry fibrous material per unit area, i.e. the mass of dry sheet per unit area, e.g. gram per square centimeter.

The fibrous material in the region(s) of a first basis weight may be elongated by about 10 to about 200%, or by about 15 to about 100%, or by about 20 to about 90%, relative to the fibrous material in the region(s) of a second basis weight. Generally, when said fibrous material consists of a carded fibrous material, it may be elongated by about 25% to about 85%. The elongation as mentioned immediately above is the effective elongation of the fibrous material, i.e. the elongation of the fibrous material after elongation and subsequent relaxation, if any. As mentioned above, it is to be understood that the elongation of the fibrous material is limited intrinsically by its nature, e.g. type of fibers, and/or by the manufacturing process but also by the desirable end properties of the fibrous material.

As a result of the elongation of the fibrous material, the basis weight of the sheet in the region(s) comprising the elongated fibrous material, referred herein as the “first basis weight”, is lower than the basis weight of the sheet in the region(s) comprising the non-elongated fibrous material, referred herein as the “second basis weight”.

The ratio between the first basis weight and the second basis weight may vary. In general, the ratio first basis weight to second basis weight may be from about 0.33:1 to about 0.91:1, or from about 0.5:1 to about 0.87:1, or from about 0.52:1 to about 0.8:1. Typically, when the fibrous material has been elongated by a factor of 100% in a region, the sheet has a decrease in basis weight from about 50% of its initial basis weight in said region.

Typically, the regions of a first basis weight may have a basis weight between about 15 to about 60 g/m², or between about 20 to about 50 g/m², or between about 25 to about 40 g/m². The regions of a second basis weight may have a basis weight between about 30 to about 100 g/m², or between about 35 to about 70 g/m², or between about 40 to about 80 g/m².

The fibrous material useful according to the present disclosure may be elongated in the cross-machine direction and/or in the machine direction. As used herein with respect to fibrous materials, the term “machine-direction” refers to the direction of travel as the fibrous material is produced, for example on nonwoven making equipment. Likewise, the term “cross-direction” refers to the direction in the plane of the fibrous material perpendicular to the machine-direction. With respect to individual wipes or sheets, the terms “machine-direction” and “cross-machine direction” refer to the corresponding directions of the wipes/sheets with respect to the fibrous material the wipe/sheet was made from. In one embodiment, the fibrous material of the sheet is elongated in the cross-machine direction.

The sheet of fibrous material may comprise one region of a first basis weight, i.e. one region wherein the fibrous material is elongated, or may comprise several regions of a first basis weight. In some embodiments, the sheet of fibrous material comprise from about 2 to about 200 regions, or from about 2 to about 100 regions, or from about 2 to about 50 regions of a first basis weight, i.e. from about 2 to about 200, or from about 2 to about 100, or from about 2 to about 50 regions wherein the fibrous material is elongated. In embodiments comprising several regions of a first basis weight, said regions are discrete regions, i.e. they are separated from each other by one or more regions of a different basis weight.

In embodiments wherein the sheet comprises several regions of a first basis weight, e.g. from about 2 to about 200, or from about 2 to about 100, or from about 2 to about 50 regions, said regions of a first basis weight may be distributed in selected areas of the sheet or they may be distributed over the whole surface of the sheet in a regular or irregular pattern.

FIGS. 1 to 5 are illustrative of embodiments wherein the regions 7 of a first basis weight are distributed in selected areas 9, 10 of the sheet 2.

FIG. 6 is illustrative of embodiments wherein the regions 7 of a first basis weight are distributed over the whole surface of the sheet 2.

Regions of a First Basis Weight in Selected Areas of the Sheet

When distributed in selected areas of the sheet, the regions of a first basis weight may be distributed in areas proximate to the edges of the sheet, such as in areas in the form of margins running along one or more edges of the sheet, such as along two opposite edges of the sheet. The margins running along one or more edges of the sheet are “selected areas” or “target area” in the sense of the present disclosure.

A “margin” as used herein is defined by the area of the sheet comprised between one selected edge of the sheet and a virtual line connecting the edges adjacent to said selected edge. Said virtual line may be parallel to the selected edge or may be curvilinear or may be a wavy line.

With reference to FIG. 1, the margin referred under the reference number 9 is defined by the area of the sheet located between the selected edge 6 and the virtual line 11 connecting the edges 3 and 4 adjacent to the selected edge 6. The margin referred under the reference number 10 is defined by the area of the sheet located between the selected edge 5 and the virtual line 12 connecting the edges 3 and 4 adjacent to the selected edge 5.

The area of the sheet located between the two margins 9, 10 is referred herein as the central area 13 of the sheet.

The overall dimensions of the sheet and margins thereof are dependent on the intended application of the wipe and can be selected accordingly. However, typically, each margin has a surface area representing up to 10% of the surface area of the sheet, or up to 20% of the total surface area of the sheet, or up to 40% of the total surface area of the sheet. In some embodiments, each margin has a surface area representing from about 5% to about 40% of the total surface area of the sheet, or from about 10 to about 35% of the total surface area of the sheet, or from about 15 to about 30% of the total surface area of the sheet. The two margins may have a same surface area, or may have a different surface area.

The central area of the sheet may have a surface area representing from about 20% to about 90% of the total surface area of the sheet, or from about 30 to about 80% of the total surface area of the sheet, or from about 40 to about 70% of the total surface area of the sheet.

When the virtual lines 11 and 12 are perpendicular to the edges of the sheet as explained above, the margins 9, 10 may have respectively a width w′ and w representing up to 10%, or up to 20%, or up to 40% of the length L or width W of the sheet. In FIG. 1, the margins 9, 10 may have a width w′ and w representing up to 10%, or up to 20%, or up to 40% of the length L of the sheet. The central area 13 of the sheet may have a width w″ representing from about 20 to about 90%, or from about 30 to about 80%, or from about 40 to about 70% of the length or width of the sheet. The central area 13 of the sheet is a region 8 of a second basis weight, i.e. the fibrous material in the central area is non-elongated.

The two margins 9, 10 may be symmetrical or be asymmetrical, e.g. one margin may have a smaller width than the other margin.

Each of the two margins of the sheet of fibrous material may comprise one region 7 of a first basis weight or may comprise several regions 7 of a first basis weight. In some embodiments, the two margins comprise respectively one region of a first basis weight. FIG. 1 illustrates an embodiment wherein each margin 9, 10 comprises one region 7 of a first basis weight. The region of a first basis weight within a margin is located between two regions 14 of a different basis weight.

In some embodiments, the two margins comprise respectively several regions of a first basis weight. In some embodiments, one margin comprises one region of a first basis weight and one margin comprises several regions of a first basis weight.

In some embodiments, each of the two margins of the sheet of fibrous material comprises several regions of a first basis weight, such as from about 2 to about 200 regions, or from about 2 to about 100 regions, or from about 2 to about 50 regions of a first basis weight. FIG. 2 represents an embodiment wherein the margins 9, 10 of the sheet of fibrous material comprise several regions 7 of a first basis weight. The regions 7 of a first basis weight are discrete regions, i.e. they are separated from each others by one or more regions 14 of a different basis weight. For instance, the regions 7 of a first basis weight may be separated from each other by one or more regions 8 of a second basis weight, said second basis weight being higher than the first basis weight. Alternatively, the regions of a first basis weight may be separated from each other by one or more regions of a third basis weight, said third basis weight being higher or lower than the first basis weight. FIG. 2 illustrates an embodiment wherein the regions 7 of a first basis weight in the margins 9, 10 are separated from each others by several regions 14 of a different basis weight. In said embodiment, the regions 7 of a first basis weight and the regions 14 of a different basis weight are discrete regions. The regions 14 of a different basis weight in the embodiments of FIGS. 1 and 2 may be regions 8 of a second basis weight.

In embodiments wherein the margins of the sheet comprise respectively several regions of a first basis weight, e.g. from about 2 to about 200, or from about 2 to about 100, or from about 2 to about 50 regions, said regions of a first basis weight may be distributed over the surface of the margins of the sheet in a regular or irregular pattern. In some embodiments, the regions of a first basis weight are in the form of stripes extending from one edge of the sheet to the opposite edge, either in the machine direction or in the cross-machine direction, as illustrated on FIGS. 1 and 2. FIGS. 1 and 2 illustrate embodiments wherein the stripes are parallel to the machine direction, i.e. the fibrous material has been elongated in the cross-machine direction. It is to be understood that in embodiments wherein the regions of a first basis weight are in the form of stripes, the regions of first basis weight may be separated from each other by regions 14 of a different basis weight, e.g. by regions of a second basis weight or regions of a third basis weight. Generally, the regions 7 of first basis weight are separated from each other by regions of a second basis weight, i.e. by regions wherein the fibrous material is non-elongated, thus forming a pattern of alternating stripes. In some embodiments, the alternating stripes may form a regular pattern, i.e. continuous pattern, or in some embodiments, they may form an irregular pattern, i.e. a discontinuous pattern. One example of wipes 1 wherein the regions 7 of a first basis weight are in the form of stripes in a regular pattern is illustrated on FIG. 2.

In the various embodiments wherein the margins of the sheet comprises several regions of a first basis weight, e.g. from about 2 to about 200, or from about 2 to about 100, or from about 2 to about 50 regions, the total surface area of said regions of a first basis weight may represent from about 2% to about 70% of the total surface area of the sheet, or from about 20% to about 65% of the total surface area of the sheet or from about 25% to about 60% of the total surface area of the sheet. Generally, the surface area of one single region of a first basis weight may represent from about 0.1 to about 35%, or from about 4 to about 30% of the total surface are of the sheet, or from about 5 to about 25% of the total surface area of the sheet.

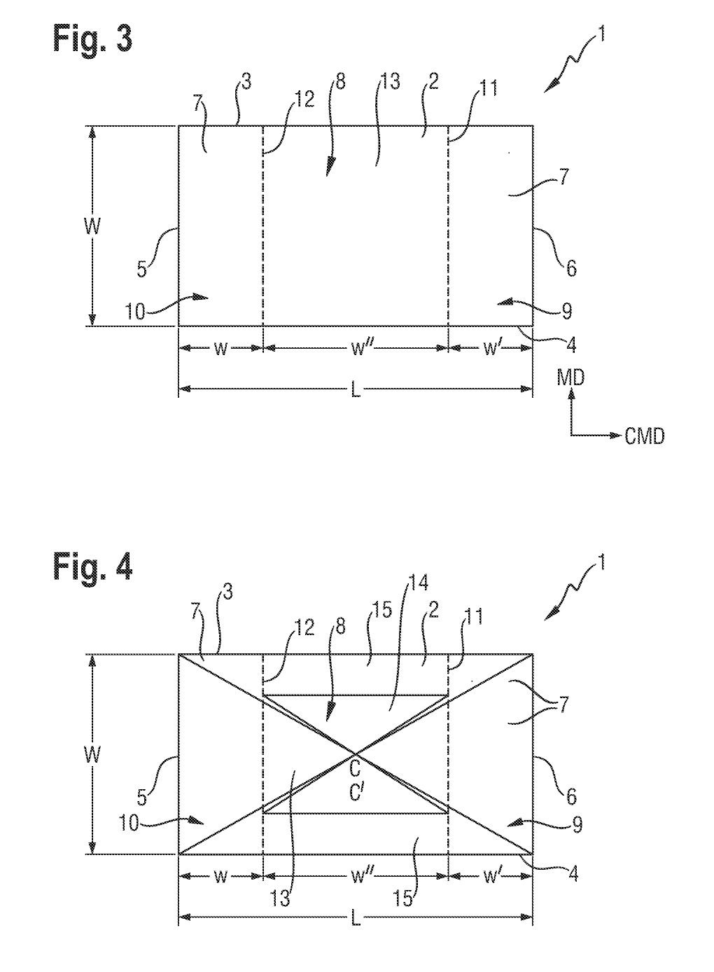

When the margins comprise respectively one region 7 of a first basis weight, said region of a first basis weight may have the surface area of the margin, i.e. the margins 9, 10 consist respectively of a region 7 of a first basis weight, as shown in FIG. 3. In these embodiments, each region of a first basis weight may have a surface area representing up to 10% of the surface area of the sheet, or up to 20% of the total surface area of the sheet, or up to 40% of the total surface area of the sheet. In some embodiments, each region of a first basis weight may have a surface area representing from about 5% to about 40% of the total surface area of the sheet, or from about 10 to about 35% of the total surface area of the sheet, or from about 15 to about 30% of the total surface area of the sheet. The two margins may have a same surface area or may have a different surface area.

Typically, in embodiments wherein the margins 9, 10 comprise one or more regions 7 of a first basis weight, the central area 13 of the sheet consists of one region 8 of a second basis weight, i.e. consists of one region wherein the fibrous material is not elongated (FIGS. 1 to 3).

FIG. 3 illustrates an embodiment wherein the two margins 9, 10 consist respectively of one region of a first basis weight and the central area 13 consists of one region of a second basis weight. The fibrous material in the regions of a first basis weight is elongated relative to the fibrous material in the region of a second basis weight. Alternatively, said sheet 2 may be described as comprising two regions 7 of a first basis weight in the form of stripes extending respectively along opposite edges of the sheet and one region 8 of a second basis weight in the form of a stripe, separating the two regions of a first basis weight. In such embodiments, the total surface area of the regions 7 of a first basis weight may represent from about 10% to about 80%, or from about 20% to about 70%, or from about 30% to about 60% of the total surface area of the sheet. In FIG. 3, the regions 7 of a first basis weight have been represented as having the same area. However, it is to be understood that the two regions 7 of a first basis weight may have a different area. For instance, the surface area of one region of a first basis weight may represent from about 5 to about 40%, or from about 10 to about 35%, or from about 15 to about 30% of the total surface area of the wipe. FIG. 3 depicts an embodiment wherein the region of a first basis weight consists of a fibrous material elongated in the cross-machine direction. However, it is to be understood that embodiments wherein the fibrous material is elongated in the machine direction are within the scope of the present disclosure.

While in some embodiments the central area 13 may consist of one region of a second basis weight, in some further embodiments, the central area 13 may comprise one region of a second basis weight, i.e. one region wherein the fibrous material is not elongated, said one region being continuous and representing from about 25% to less than 100% of the total surface area of the central area, or from about 35% to less than 100% of the total surface area of the central area, or from about 50% to less than 100% of the total surface area of the central area. In such embodiments, the remaining part of the central area may comprise fibrous material that has been elongated 15. FIG. 4 is illustrative of such embodiments. In some embodiments, the region of a second basis weight in said central area represents about 50%, or about 60%, or about 80% of the total surface area of the central area.

Generally, when the central area 13 comprises one region of a second basis weight representing from about 25%, or from about 35%, or from about 50% to less than 100% of the total surface area of the central area, said region of a second basis weight 14 extends in the plane of the sheet from the center C of the sheet towards the edges of the sheet and towards the virtual lines delimiting the central area from the margins. By center of the sheet as used herein, it is meant the point C wherein the diagonals 16, 17 of the sheet intersect in the plane. In some embodiments, where the region of a second basis weight of the central area 13 is rectangular or square in shape, the center C′ of said region 14 of a second basis weight may be congruent with the center C of the sheet, i.e. the center C′ of the second region and the center C of the sheet are a single and same point (see FIG. 4).

In embodiments wherein the central area does not consist of a single region of a second basis weight, i.e. wherein the central comprise one region of a second basis weight representing from about 25%, or from about 35%, or from about 50% to less than 100% of the total surface area of the central area, the central area may further comprise one or more regions, such as two regions, of a first basis weight, or one or more regions, such as two regions of a third basis weight, the first and third basis weight being lower than the second basis weight. In some embodiments, the regions of a first basis weight, or of a third basis weight, of the central area lie close to the edges of the sheet (for example along one edge or two edges of the sheet). FIG. 4 illustrates an embodiment of a wipe 1 wherein the central area 13 comprises one region 8 of a second basis weight and two regions 7 of a first basis weight.

Embodiments wherein the regions 7 of a first basis weight are distributed within margins running along opposite edges of the sheet may be particularly desirable. Wipes according to such embodiments tend to deliver to consumers the right balance of properties in terms of strength, softness, coverage, thickness, cleaning performance. Some embodiments of said wipes may be manufactured at lower costs.

It was observed that typically, consumers use the central portion of the wipe when wiping a surface, the edges acting mainly as barriers to protect the hands from soiling during the cleaning task. Wipes according to embodiments wherein the regions of a first basis weight are distributed within margins running along opposite edges of the sheet, have, as disclosed above, a central area 13 which comprises a fibrous material of higher basis weight. Said central area provides for efficient cleaning, e.g. good strength, good coverage, good thickness are maintained in the central area of the wipe, whereas the margins of lower basis weight offer notably protection for users' hands. These distinctive wipes, i.e. wipes having margins of lower basis weight vs. the central area, offer the uniqueness of associating efficient cleaning and efficient hands protection with fibers usage decrease and with reduction of manufacturing costs. The central area of the wipe provides for strength, softness, opacity whereas the margins provide for economization of fibers whilst still protecting efficiently users' hands from soiling during the cleaning task. When the wipes are intended to clean the floor, their central area, which is generally the portion that comes in contact with the floor and dirt, maintains its caliper and structure providing desired cleaning performance and the margins, which are typically used to removably attached the wipe to the cleaning implement, e.g. wrapped around the mop head, and not used for cleaning, contribute to save large amount of material.

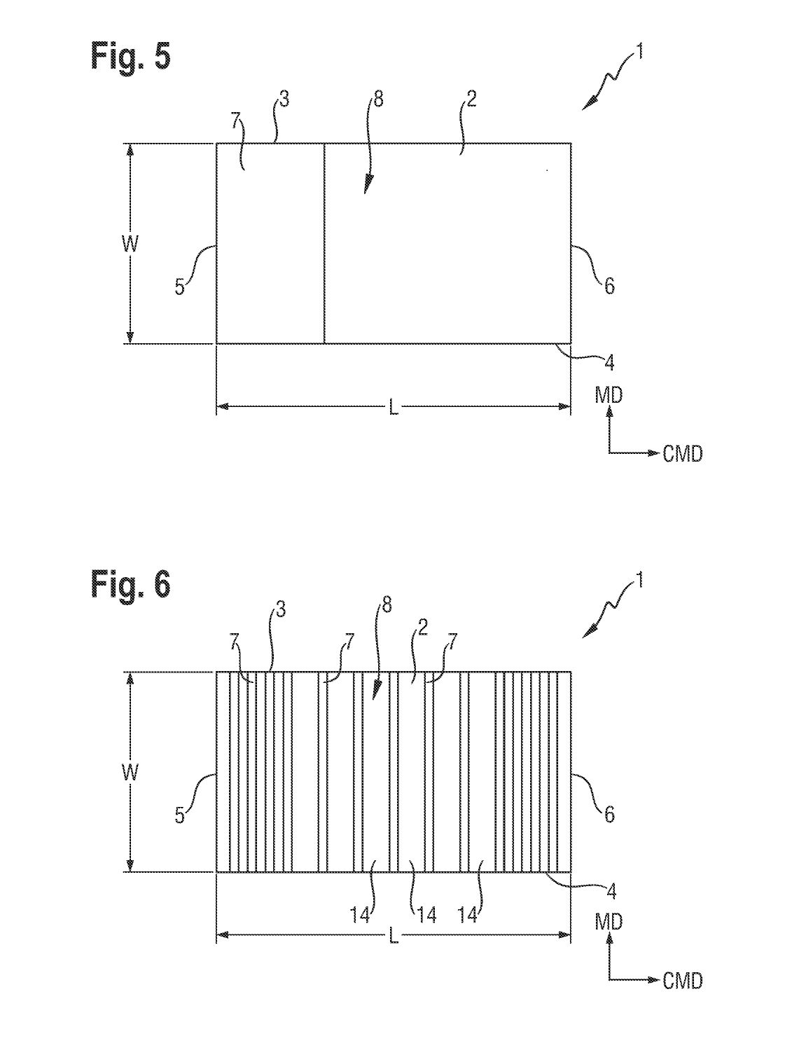

FIG. 5 illustrates a further embodiment of a wipe according to the present disclosure. The wipe 1 comprises a sheet of fibrous material 2. The sheet comprises one region of a first basis weight 7 extending continuously along one edge of the wipe. Said region of a first basis weight is adjacent to one region of a second basis weight 8. In such embodiment, the area of the region of a first basis weight 7 may represent from about 5 to about 60%, or from about 10 to about 50% or from about 15 to about 40% of the total surface area of the sheet. FIG. 5 depicts an embodiment wherein the region of a first basis weight 7 consists of a fibrous material elongated in the cross-machine direction. However, it is to be understood that embodiments wherein the fibrous material is elongated in the machine direction are within the scope of the present disclosure.

Regions of a First Basis Weight Distributed Over the Whole Surface of the Sheet

In some embodiments, the regions of a first basis weight are distributed over the whole surface of the sheet.

In some embodiments, the sheets may comprise from about 2 to about 200, or from about 2 to about 100, or from about 2 to about 50 regions of a first basis weight 7 distributed over the whole surface of the sheet 2. The regions of a first basis weight may be in the form of stripes extending from one edge of the sheet to the opposite edge, they may extend either in the machine direction or in the cross-machine direction. In some embodiments, the alternating stripes may form a regular pattern, i.e. continuous pattern, or in some embodiments, they may form an irregular pattern, i.e. a discontinuous pattern. The regions of a first basis weight 7 are discrete regions. They may be separated from each other by one region of a second basis weight or by several regions of a second basis weight.

FIG. 6 illustrates an embodiment wherein the regions of a first basis weight 7 are in the form of stripes extending from one edge 3 of the sheet to the opposite edge 4. The stripes may be separated by regions of a second basis weight 7, i.e. by regions wherein the fibrous material is non-elongated, thus forming a pattern of alternating stripes, or the stripes may be separated by regions 8 of a second basis weight and regions 14 of a different basis weight, such as regions of a third basis weight. In this embodiment, the stripes are more condensed towards the edges of the wipe. However, the stripes could be uniformly distributed over the whole surface of the wipe.

In the various embodiments wherein the sheet comprises several regions of a first basis weight, e.g. from about 2 to about 200, or from about 2 to about 100, or from about 2 to about 50 regions, the total surface area of said regions of a first basis weight may represent from about 2% to about 70% of the total surface area of the sheet, or from about 20% to about 65% of the total surface area of the sheet or from about 25% to about 60% of the total surface area of the sheet. Generally, the surface area of one single region of a first basis weight may represent from about 0.1 to about 35% of the total surface area of said regions of a first basis weight.

While embodiments wherein the sheet comprises at least one region of a first basis weight and at least one region of a second basis weight have been illustrated, it is to be understood that the sheet may comprise further regions of further basis weights, such as for instance at least one further region of a third basis weight, at least one further region of a fourth basis weight.

Method for Manufacturing the Wipes According to the Present Disclosure

The wipes according to the present disclosure may be manufactured by a method referred to as mechanical activation of a fibrous material. Mechanical activation, or incremental stretching as it is sometimes referred to, involves permanently stretching or elongating a fibrous structure or regions of a fibrous structure in one or more directions, i.e. machine direction or cross-machine direction. As the fibrous material is stretched or elongated, some of the fibers, inter-fiber bonds, and/or intra-fiber bonds are believed to be broken. Known processes for activating a fibrous material typically involve passing the fibrous material through one or more pairs of activation rolls. The activation rolls generally have three-dimensional surface features (e.g., teeth and grooves, peaks and channels, or corrugations), which are configured to operatively engage one another. The three-dimensional surface features on the rolls are typically complementary (i.e., fit together in an intermeshing fashion) such that the rolls are sometimes referred to as being a “matched” or “mated” pair. As the fibrous structure passes through the matched pair of activation rolls, it is subjected to relatively high localize mechanical stress from the intermeshing three-dimensional surface features. Most, if not all, of the fiber/bond breaking takes place in these areas of high localized mechanical stress. Upon successful completion of the activation process, the activated fibrous structure exhibits an increase in length (elongation) in one or more dimension, i.e. machine direction or cross machine direction, depending on the direction of activation.

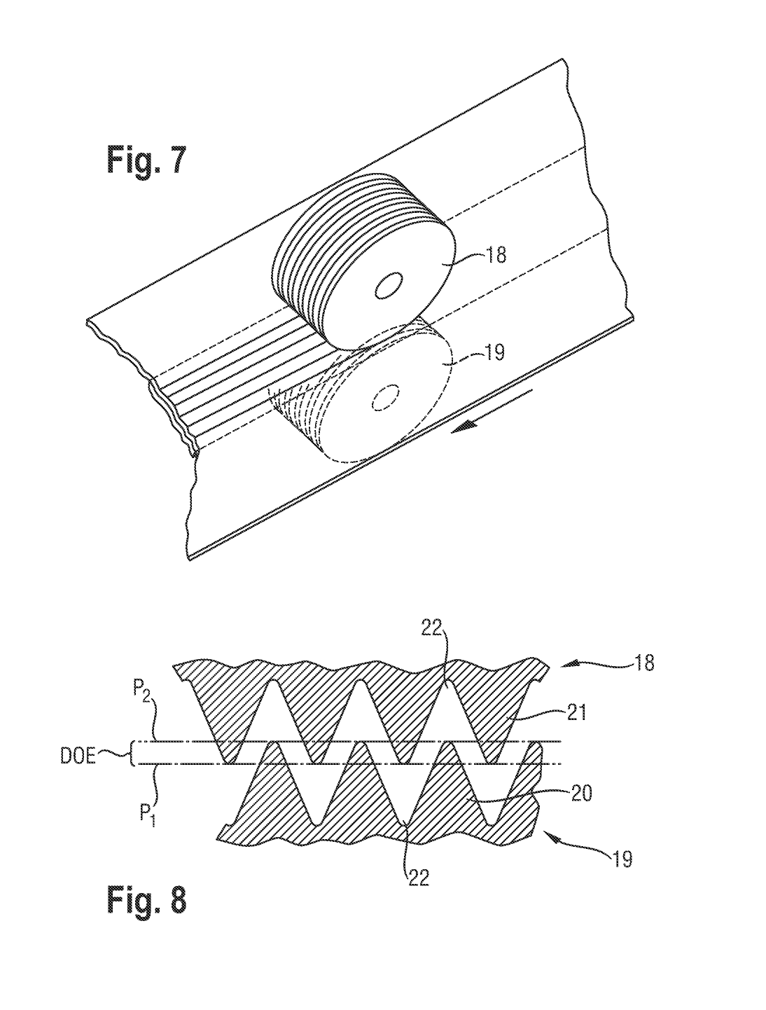

The one or more regions of a first basis weight of the sheet making the wipe of the present disclosure may be achieved by activating portions of the fibrous material. For activating portions of the fibrous material, the fibrous material is first fed through a pair of matched activation rolls that have raised portions extending in the “axial direction” of the rolls (i.e., parallel to the axis of rotation of the rolls) to activate the fibrous material in a first direction at the intended location. For instance, the portion to be activated is passed between a pair of activation rolls having three-dimensional surfaces. The axially extending raised portions of the rolls intermesh in a manner similar to the way the teeth of two gears typically intermesh. The rolls may be positioned such that the intermeshing teeth do not substantially contact one another in order to avoid damaging the teeth and/or roll. An example of a process for mechanically activating portions of a fibrous material is schematically represented in FIGS. 7 and 8. The degree of activation may be adjusted by varying the number of engaging portions and recess portions and the depth of engagement of the activation rolls 18 and 19 on the fibrous material. While the exact configuration, spacing and depth of the complementary grooves on the uppermost and lowermost activation rolls will vary, depending upon such factors as the amount of elongation desired, two pairs of activation rolls, each having a peak-to-peak groove pitch of approximately 3.8 mm, an included angle of approximately 18° as measured at the peak, and a peak-to-valley groove depth of approximately 7.6 mm have been employed in one embodiment of the present disclosure. With reference to FIG. 8, which shows a portion of the intermeshing of the engaging portions 20 and 21 of activation rolls 18 and 19, respectively, the term “pitch” refers to the distance between the apexes of adjacent engaging portions. The pitch can be between approximately 0.02 to approximately 0.30 inches (0.51-7.62 mm), and is typically between approximately 0.05 and approximately 0.15 inches (1.27-3.81 mm). The height (or depth) of the teeth is measured from the base of the tooth to the apex of the tooth, and is typically equal for all teeth. The height of the teeth can be between approximately 0.10 inches (2.54 mm) and 0.90 inches (22.9 mm), and is typically approximately 0.25 inches (6.35 mm) and 0.50 inches (12.7 mm). The engaging portions 20 in one activation roll can be offset by one-half the pitch from the engaging portions 21 in the other activation roll, such that the engaging portions of one pressure applicator (e.g., engaging portion 20) mesh in the recess portions 22 (or valleys) located between engaging portions in the corresponding activation roll. The offset permits intermeshing of the two activation rolls when the activation rolls are “engaged” or in an intermeshing, operative position relative to one another. In one embodiment, the engaging portions of the respective activation rolls are only partially intermeshing. The degree to which the engaging portions on the opposing activation roll intermesh is referred to herein as the “depth of engagement” or “DOE” of the engaging portions. As shown in FIG. 8, the DOE is the distance between a position designated by plane P1 where the apexes of the engaging portions on the respective activation rolls are in the same plane (0% engagement) to a position designated by plane P2 where the apexes of the engaging portions of one activation roll extend inward beyond the plane P1 toward the recess portions on the opposing activation roll.

As the fibrous structure passes through the pair of rolls, it is activated in the direction of travel of the fibrous material, referred to as the machine-direction. In some instances, a matched pair of rolls may include surface features that resemble a line of alternating discs of larger and smaller diameters, sometimes referred to as a ring-rolling configuration. Ring-rolling is typically used to activate a fibrous structure in the direction orthogonal to the machine direction, also referred to as the cross-direction.

The elongated fibrous material may slightly relax as it “exits” the activation rolls. One of ordinary skill in the art will appreciate that other processes for mechanically activating a fibrous material may be used and still provide the same benefits. For instance, another method for activating portions of a fibrous structure may include a method wherein the fibrous structure is first clamped between two plates, then a force is applied to elongate the fibrous material as desired and the clamps are removed to provide a material which is elongated in the regions comprised between the clamps.

The process of making wipes according to the present disclosure may include the steps of:

(a) obtaining a web of fibrous material,

(b) elongating portions of said web of fibrous material,

(c) slitting the web in the machine-direction to provide a web of fibrous material having the width or length of the final wipe,

(d) converting the fibrous web into wipes.

Alternatively, the process of making wipes according to the present disclosure may include the steps of:

(a) obtaining a web of fibrous material,

(b) elongating portions of said web of fibrous structure to provide a web of fibrous material having the width or length of the final wipe,

(c) converting the fibrous web into wipes.

The elongation of the fibrous material may be performed starting with a “narrow” web of fibrous material, i.e. a web of fibrous material having a width that will lead to a wipe having a desired length or width after elongation, or alternatively the elongation of the fibrous material may be performed starting with a “large” web of fibrous material. When starting with a large web of fibrous material, the web is then slitted after the elongation process to provide a wipe having the desired length or width. The slit may occur in the middle of an elongated region to provide wipes having elongated regions along the edges.

The wipes may be impregnated with a lotion to provide the so-called wet wipes. The impregnation of the fibrous material with the lotion may be performed prior to the step of elongation or after the step of elongation.

The wipes may be stacked and packed in a flexible container or in a rigid container.

### Example

The fibrous material made of 80% Polypropylene/20% Viscose, 45 gsm as supplied by Ahlstrom, having an original width of 162 mm was passed between the activation rolls illustrated on FIG. 8. The activation rolls have a peak separation of 0.100 inches (2.54 mm) and a diameter of 6.0 inches (152.4 mm). Each roll is 10.0 inches (254 mm long). The grooved rolls have a peak separation of 0.100 inches (2.54 mm). The fibrous material speed at the entrance of the apparatus was 80 m/min. The fibrous material was thus elongated in the cross-machine direction to provide a fibrous material having a total width of 180 mm, of which 90 mm of elongated areas along opposite edges of the fibrous material (two margins having a width of 45 mm), thus providing 10% of material savings. The fibrous material in the elongated region is elongated by 25% relative to the fibrous material in the non-elongated region.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A wipe comprising a sheet of fibrous material, said sheet comprising:
at least one region of a first basis weight;
at least one region of a second basis weight;
wherein the fibrous material in said region(s) of a first basis weight of said sheet is elongated relative to the fibrous material in said region(s) of a second basis weight of said sheet.

2. The wipe according to claim 1 wherein the fibrous material in said region(s) of a first basis weight is elongated relative to the fibrous material in said region(s) of a second basis weight by 10 to 200%.

3. The wipe according to claim 1 wherein the ratio first basis weight to second basis weight is from 0.33:1 to 0.91:1.

4. The wipe according to claim 1 wherein said sheet has from 2 to 200 regions of a first basis weight.

5. The wipe according to claim 1 wherein said region(s) of a first basis weight are distributed within margins running along one or more edges of the sheet.

6. The wipe according to claim 1 wherein said region(s) of a first basis weight are distributed within two margins running along opposite edges of the sheet.

7. The wipe according to claim 1 wherein said region(s) of a first basis weight are distributed within two margins running along opposite edges of the sheet and wherein each margin represents up to 40% of the total surface area of the sheet.

8. The wipe according to claim 1 wherein said region(s) of a first basis weight are distributed within two margins running along opposite edges of the sheet and wherein each margin represents up to 40% of the total surface area of the sheet and wherein each margin consists of a region of a first basis weight.

9. The wipe according to claim 1 wherein the regions of a first basis weight are in the form of stripes extending from one edge of the sheet to an opposite edge.

10. The wipe according to claim 1 wherein the regions of a first basis weight are in the form of stripes extending from one edge of the sheet to an opposite edge and being parallel to the machine direction.

11. The wipe according to claim 1 wherein the total surface area of said region(s) of a first basis weight represents from 20% to 65% of the total surface area of said sheet.

12. The wipe according to claim 1 wherein the surface area of one region of a first basis weight represents from 5% to 40% of the total surface area of the sheet.

13. The wipe according to claim 1 wherein the fibrous material in said region(s) of a first basis weight is elongated in the cross-machine direction.

14. The wipe according to claim 1 further comprising a water-based composition.

15. A process for making a wipe comprising:
providing a web of fibrous material;
elongating portions of said web of fibrous material; and
converting the fibrous web into dry wipes or wet wipes.

16. The process for making a wipe according to claim 15 further comprising slitting the web to provide a web of fibrous material having the width or length of the final wipe.
